(19) United States
(12) Patent Application Publication
(10) Pub. No.: US 2017/0163509 A1
(43) Pub. Date: Jun. 8, 2017

(54) INTER-NODE DISTANCE METRIC METHOD AND SYSTEM

(71) Applicants: LE HOLDINGS (BEIJING) CO., LTD., Beijing (CN); LECLOUD COMPUTING CO., LTD., Beijing (CN)

(72) Inventor: Hongfu LI, Beijing (CN)

(21) Appl. No.: 15/246,226

(22) Filed: Aug. 24, 2016

Related U.S. Application Data
(63) Continuation of application No. PCT/CN2016/088865, filed on Jul. 6, 2016.

(30) Foreign Application Priority Data
Dec. 7, 2015 (CN) 201510888109.8

(51) Int. Cl. H04L 12/26; H04L 29/08

(52) U.S. Cl. CPC H04L 43/0864; H04L 67/32; H04L 67/10; H04L 67/42

(57) ABSTRACT

An inter-node distance metric method are provided. The method includes: acquiring a data transmission rate, a round-trip time and a packet loss rate between a first node and a second node; and calculating a distance between the first node and the second node based on the data transmission rate, the round-trip time and the packet loss rate, wherein the data transmission rate is inversely proportional to the distance, and the round-trip time and the packet loss rate are proportional to the distance.

### CROSS REFERENCE TO RELATED APPLICATIONS

This application is a continuation of International Application No. PCT/CN2016/088865, filed on Jul. 6, 2016, which is based upon and claims priority to Chinese Patent Application No. 201510888109.8, filed on Dec. 7, 2015, the entire contents of which are incorporated herein by reference.

### TECHNICAL FIELD

The present disclosure relates to the technical field of internet, and more particularly to an inter-node distance metric method and system.

### BACKGROUND

The CDN (Content Delivery Network) is an intelligent virtual network based on the existing Internet and formed by placing node servers throughout the network. The CDN can re-direct a user request to the nearest service node in real time according to comprehensive information, such as a network traffic condition, the connection conditions of the nodes, a load condition, a distance from each node to a user and a response time to the request, so that a node relatively closer to the user can be selected to send required content to the user, thereby relieving network congestion and improving the website response speed.

During the implementation of the present disclosure, the inventor found that in the prior art, a distance between two nodes is calculated based on a downloading speed between two nodes. However, using only the downloading speed to calculate the distance between the two nodes may be inaccurate and unreliable in the prior art. Said closest node selected for a user based on the calculated distance is not necessarily the closest node actually, so the best services may not be provided to users. Thus, there is a need to find better solutions to estimate the distance between two nodes.

### SUMMARY

The present disclosure provides an inter-node distance metric method and system to solve the technical problem of inaccurate and unreliable inter-node distance metric.

In a first aspect of the present disclosure, there is provided an inter-node distance metric method. The method includes: acquiring a data transmission rate, a round-trip time, and a packet loss rate between a first node and a second node; and calculating a distance between the first node and the second node based on the data transmission rate, the round-trip time, and the packet loss rate, where the data transmission rate is inversely proportional to the distance, and the round-trip time and the packet loss rate are proportional to the distance.

In a second aspect of the present disclosure, there is provided an inter-node distance metric system. The system includes one or more processors configured to: acquire a data transmission rate, a round-trip time, and a packet loss rate between a first node and a second node; and calculate a distance between the first node and the second node based on the data transmission rate, the round-trip time, and the packet loss rate, where the data transmission rate is inversely proportional to the distance, and the round-trip time and the packet loss rate are proportional to the distance.

In a third aspect of the present disclosure, there is provided a non-transitory computer-readable medium for estimating inter-node distance. The non-transitory computer-readable medium may include executable instructions, where the executable instructions, when executed by an electronic device including a processor, cause the electronic device to: acquire a data transmission rate, a round-trip time and a packet loss rate between a first node and a second node; and calculate a distance between the first node and the second node based on the data transmission rate, the round-trip time and the packet loss rate, wherein the data transmission rate is inversely proportional to the distance, and the round-trip time and the packet loss rate are proportional to the distance.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of an inter-node distance metric method according to an embodiment of the present disclosure;

FIG. 2 shows a flow chart of the inter-node distance metric method according to another embodiment of the present disclosure;

FIG. 3 shows a schematic structural drawing of an inter-node distance metric system according to an embodiment of the present disclosure;

FIG. 4 shows a schematic structural drawing of the inter-node distance metric system according to another embodiment of the present disclosure;

FIG. 5 is an architecture drawing of the inter-node distance metric method and system provided by the embodiments of the present disclosure; and

FIG. 6 shows a schematic drawing of electronic equipment according to an embodiment of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

According to the inter-node distance metric method and system provided by the embodiments of the present disclosure, the distance between the two nodes is determined by calculating the data transmission rate, the round-trip time and the packet loss rate between the first node and the second node during communication as well as weight-summing the data transmission rate, the round-trip time and the packet loss rate, so that the finally determined distance between the two nodes is more accurate and reliable. Thus, a method for determining the most reliable and closest node for CDN scheduling is provided, the quality of services provided to users is improved, and the user experience is ensured.

It should be noted that, embodiments of the present application and the technical features involved therein may be combined with each other in case they are not conflict with each other.

The present disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, an electronic device, a mini-computer, a mainframe computer, a distributed computing environment including any of the above-listed systems or devices.

The present disclosure can be described in a general context where a computer executes computer-executable instructions, such as program modules. Typically, program modules include routines, programs, objects, components, data structures, etc. which perform certain tasks or implement certain abstract data types. The present disclosure can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “comprise”, “include” and the like are to be construed as including not only the elements described, but also those elements not specifically described, or further including elements which are essential to such process, method, article or device. Unless the context clearly requires, throughout the description and the claims, elements defined by recitation with “comprising . . . ” should not be construed as exclusive from the process, method, article or device including said elements of other equivalent elements.

In an actual network environment, not only the downloading speed affects the distance between the two nodes, but other factors affect the distance between the two nodes. For example, there are factors such as an RTT (Round-trip Time) between the two nodes and a packet loss rate between the two nodes during communication. Therefore, using only the downloading speed to calculate the distance between the two nodes may be inaccurate and unreliable. Said closest node selected for a user based on the calculated distance is not necessarily the closest node actually, so the best services may not be provided to users. As a result, the user experience is affected.

As shown in FIG. 1, an inter-node distance metric method according to one or more embodiments of the present disclosure includes:

S11: acquiring by a scheduling center (namely, a separate server or a server cluster) in a CDN system a data transmission rate, a round-trip time and a packet loss rate between a first node and a second node; and

S12: calculating by the scheduling center the distance between the first node and the second node based on the data transmission rate, the round-trip time and the packet loss rate, wherein the data transmission rate is inversely proportional to the distance, and the round-trip time and the packet loss rate are proportional to the distance.

The data transmission rate, the round-trip time and the packet loss rate in the present embodiment are acquired based on a request message sent from a first node (namely, a first CDN server) to a second node (namely, a second CDN server). The request message may be a historical request and corresponding historical data between the two nodes in practical application, or test request information specially sent for calculating the distance between the two nodes. Likewise, the data transmission rate, the round-trip time and the packet loss rate between the first node and the second node may be determined based on information acquired according to the historical data or the test request information.

In the present embodiment, the scheduling center calculates the distance between the two nodes by comprehensively considering a downloading speed, the round-trip time and the packet loss rate between the two nodes. The downloading speed is used for indicating data transmission speed between the two nodes, and the higher the downloading speed is, the closer the two nodes is, so that the downloading speed is inversely proportional to the distance between the two nodes. The round-trip time is a time spent for a complete communication between the two nodes, and the shorter the round-trip time is, the closer the two nodes is. The packet loss rate reflects the completeness of transmitted information during communication between the two nodes, and the larger the packet loss rate is, the more incomplete the transmitted information is. That is, the larger the packet loss rate is, the farther the distance between the two nodes is. Therefore, the finally determined distance between the two nodes is more reliable, thereby providing more reliable scheduling bases for a CDN system in content distributing to ensure the user service quality, and helping to improve the user experience.

The data transmission rate and the round-trip time in the present embodiment are obtained by direct monitoring. Simply speaking, the round-trip time shows a time from a point that a sender starts to send data to a point that the sender receives confirmation information from a recipient. The round-trip time is an important performance index in a computer network, and represents the time delay from a point that the sender starts to send data to a point that the sender receives confirmation information from the recipient, wherein the recipient immediately sends the confirmation information after receiving the data. An RTT value is determined by three components: a link propagation time, an end system processing time and a queuing and processing time in a cache of a router. Values of the link propagation time and the end system time, as a TCP connection, are relatively fixed, and the queuing and processing time in the cache of the router will change along with the congestion conditions of the entire network, so that the change of the RTT reflects the network congestion conditions to some extent.

The packet loss rate, or loss tolerance refers to the ratio of dropped packet quantity and transmitted data sets in a test, and a calculation method is “[(input packets-output packets)/input packets]*100%”. In the present embodiment, the packet loss rate is equal to [(data transmitted by the first node-data received by the second node)/the data transmitted by the first node]*100%.

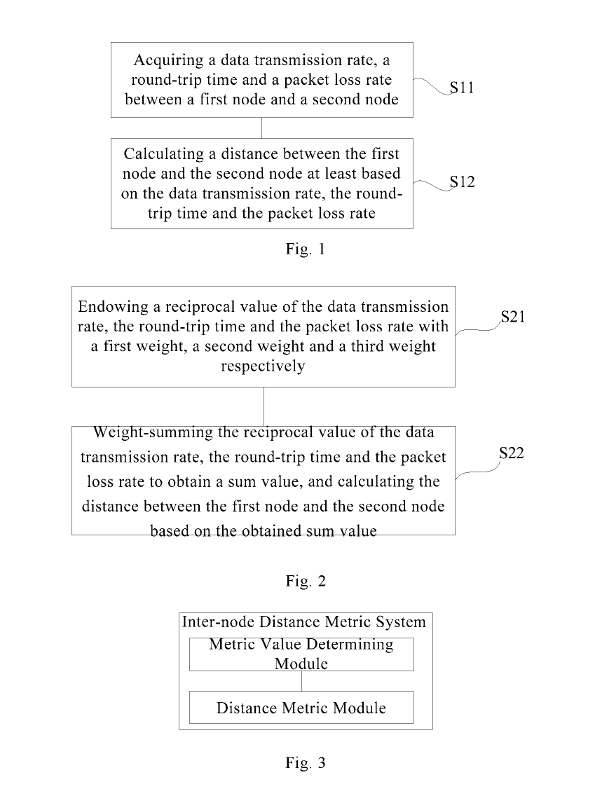

As shown in FIG. 2, in some embodiments, calculating by the scheduling center the distance between the first node and the second node based on the data transmission rate, the round-trip time and the packet loss rate includes:

S21: endowing by the scheduling center a reciprocal value of the data transmission rate, the round-trip time and the packet loss rate with a first weight, a second weight and a third weight respectively; and

S22: weight-summing by the scheduling center the reciprocal value of the data transmission rate, the round-trip time and the packet loss rate to obtain a sum value, and calculating the distance between the first node and the second node based on the obtained sum value.

In the present embodiment, the scheduling center endows the reciprocal value of the data transmission rate, the round-trip time and the packet loss rate with a first weight, a second weight and a third weight respectively and performs summing on the reciprocal value of the data transmission rate, the round-trip time and the packet loss rate to calculate the distance between the two nodes, wherein the first weight, the second weight and the third weight can be adjusted as required to more accurately and reliably calculate the distance between the nodes. For example, if the network environment changes (for instance, network operators adjust the network environments in different areas), the influence proportions of the reciprocal value of the data transmission rate, the round-trip time and the packet loss rate to the inter-node distance metric inevitably changes, so that the influence proportions of the reciprocal value of the data transmission rate, the round-trip time and the packet loss rate to the inter-node distance metric can be adjusted by adjusting the first weight, the second weight and the third weight, thereby calculating the distance between the two nodes more accurately and reliably.

In some embodiments, the first weight, the second weight and the third weight are dynamically changed, and satisfy the following formulas:

αi=Ai βi=Bi γi=Ci, and

α′0=A0 β′0=B0 γ′0=C0, wherein

α′i is determined based on α′i-1 and αi, β′i is determined based on β′i-1 and βi, and γ′i is determined based on γ′i-1 and γi; and

α′i is an i-th value of the first weight, β′i is an i-th value of the second weight, γ′i is an i-th value of the third weight, αi represents a first reference weight, βi represents a second reference weight, γi represents a third reference weight, Ai, Bi and Ci are values determined based on a reference model established based on a relationship between inter-node distances in a plurality of nodes and inter-node historical transmission rates, and a relationship between inter-node historical round-trip times and inter-node historical packet loss rates, and i may be selected from 1 to N.

In the present embodiment, the model refers to a minimum spanning tree determined based on historical performance data of distances among all nodes, which are obtained from network operators or historical statistical data. Or, the model generates the minimum spanning tree based on historical data of the mutual response quality of all nodes.

With respect to the technical scheme of the present disclosure, given the distance between the two nodes is L=α′i/v+β′ir+γ′id (Formula 1), wherein α′i, β′i and γ′i are undetermined coefficients greater than 0 and less than 1, v represents the downloading speed, r represents the round-trip time, and d represents the packet loss rate.

Various points in the minimum spanning tree generated in the present embodiment are separate CDN nodes. Moreover, a distance between every two nodes is already fixed, and is already quantized to a fixed distance value. Distances between two nodes in all nodes and historical transmission rates, historical round-trip times and historical packet loss rates between every two nodes are substituted into the formula 1 to determine the three weighting factors in the formula 1.

The historical transmission rates, the historical round-trip times and the historical packet loss rates between every two nodes are historical data within a fixed period from a current time. For instance, they may be historical data within 10 days from the current time. The first, second and third weights are continually updated before determining according to a preset time interval (e.g., 10 days). In the first calculation, the obtained α′0=A0, β′0=B0 and γ′0=C0 are respectively used as the first weight, the second weight and the third weight. In the second calculation, α1=A1, β1=B1 and γ1=C1 are obtained. Here, the first weight α′1 is determined by weight-summing the α′0 and α1, the second weight β′1 is determined by weight-summing the β′0 and β1, and the third weight γ′1 is determined by weight-summing the γ′0 and γ1. So, following first, second and third weights are determined by repeating the above processing. Thus, a currently used weight value is determined by weight-summing a former weight value and a currently calculated weight value, so that the practically used weight value can be adjusted between the former weight value and the currently calculated weight value as required to determine a more accurate practically used weight value, thereby ensuring the inter-node distance metric accuracy and reliability.

In some embodiments, the step that α′i is determined based on α′i-1 and αi, β′i is determined based on β′i-1 and βi, and γ′i is determined based on γ′i-1 and γi is embodied as:

α′i=(K−1)/Kα′i−1+1/Kαi,

β′i=(K−1)/Kβ′i−1+1/Kβi,

and

γ′i=(K−1)/Kγ′i−1+1/Kγi,

wherein
K is a positive integer.

In the present embodiment, the scheduling center sets a weighting factor, (K−1)/K, for a former weight and a weighting factor, 1/K, for a currently calculated weight, and performs weight-summing to determine a practically used weight to enable the finally obtained practically used weight to be relatively closer to the former weight (because (K−1)/K is greater than or equal to 1/K), so as to avoid much difference between the practically used weight and the former weight. Thus, weight change caused by sudden change (abnormal adjustment) of the network environment is avoided, thereby ensuring the inter-node distance metric accuracy and reliability.

In some embodiments, the sum of the first weight, the second weight and the third weight is 1. That is, the first, second and third weights are subjected to a normalization processing, so as to more reasonably adjust the proportions among the reciprocal value of a data transmission rate, a round-trip time and a packet loss rate.

In addition, the present disclosure further provides a CDN scheduling method, in which the inter-node distance metric method according to any of the above embodiments is adopted to determine a CDN node closest to a request user to be dispatched to the requesting user.

Hardware processor can be used to implement relevant function module of embodiments of the present disclosure.

It should be noted that the foregoing embodiments of method are described as a combination of a series of actions for the sake of brief description. The skilled of the art could understand that the application is not restricted by the order of actions as described, because some steps may be carried out in other order or simultaneously in the present application. Further, it should also be understood by the skilled in the art that the embodiments described in the description are preferable, and hence some actions or modules involved therein are not essential to the present application. In the above embodiments, different emphasis is placed on respective embodiments, and hence for those portions without a detailed description in an embodiment, reference can be made to relevant portions in other embodiments.

As shown in FIG. 3, the embodiments of the present disclosure further provide an inter-node distance metric system, including:

a metric value determining module configured to acquire a data transmission rate, a round-trip time and a packet loss rate between a first node and a second node; and

a distance metric module configured to calculate a distance between the first node and the second node based on the data transmission rate, the round-trip time and the packet loss rate determined by the metric value determining module, wherein the data transmission rate is inversely proportional to the distance, and the round-trip time and the packet loss rate are proportional to the distance.

The inter-node distance metric system in the present embodiment may be a separate server or a server cluster, wherein each module may be a separate server or a server cluster. Thus, interaction between the above modules is that between the servers or the server clusters corresponding to the modules, and the plurality of servers or server clusters corresponding to the modules together form a scheduling server provided by the present disclosure.

Particularly, the scheduling server formed by the servers or server clusters corresponding to the modules includes:

a metric value determining server or server cluster configured to acquire a data transmission rate, a round-trip time and a packet loss rate between a first node and a second node; and

a distance metric server or server cluster configured to calculate the distance between the first node and the second node based on the data transmission rate, the round-trip time and the packet loss rate determined by the metric value determining server or server cluster, wherein the data transmission rate is inversely proportional to the distance, and the round-trip time and the packet loss rate are proportional to the distance.

In an alternative embodiment, several modules in the above multiple modules together form a server or server cluster. For example, the metric value determining module and the distance metric module form a server or server cluster. In the present embodiment, the scheduling center calculates the distance between the two nodes by comprehensively considering the downloading speed, the round-trip time and the packet loss rate between the two nodes. The downloading speed is used for indicating data transmission speed between the two nodes, and the higher the downloading speed is, the closer the two nodes is, so that the downloading speed is inversely proportional to the distance between the two nodes. The round-trip time is a time spent for a complete communication between the two nodes, and the shorter the round-trip time is, the closer the two nodes is. The packet loss rate reflects the completeness of transmitted information during communication between the two nodes, and the larger the packet loss rate is, the more incomplete the transmitted information is. That is, the larger the packet loss rate is, the farther the distance between the two nodes is. Therefore, the finally determined distance between the two nodes is more reliable, thereby providing more reliable scheduling bases for a CDN system in content distributing to ensure the user service quality, and helping to improve the user experience.

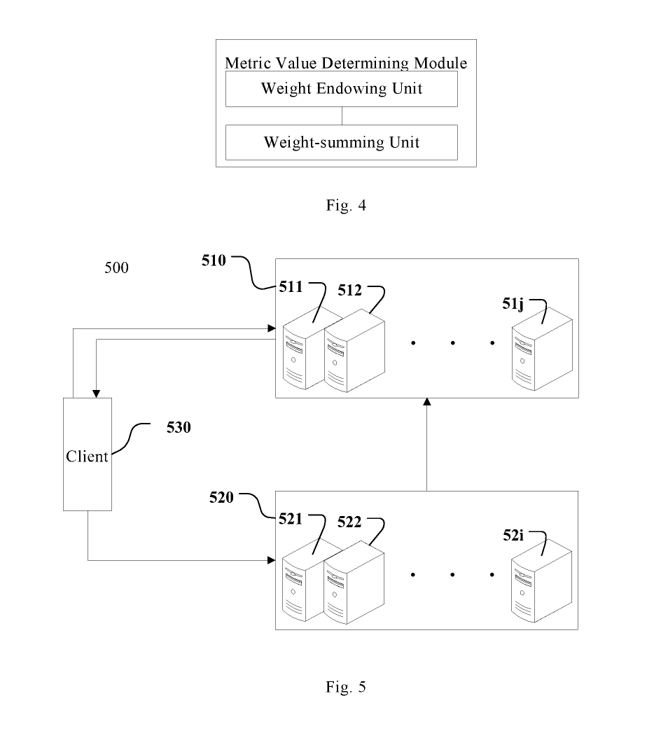

As shown in FIG. 4, in some embodiments, the distance metric module includes:

a weight endowing unit configured to endow a reciprocal value of the data transmission rate, the round-trip time and the packet loss rate with a first weight, a second weight and a third weight respectively; and

a weight-summing unit configured to perform weight-summing on the reciprocal value of the data transmission rate, the round-trip time and the packet loss rate to obtain a sum value based on the first weight, the second weight and the third weight determined by the weight endowing unit, and calculate the distance between the first node and the second node based on the obtained sum value.

In the present embodiment, the distance metric module is a separate server or server cluster, wherein each unit may be a separate server or server cluster. Thus, interaction between the above units is that between the servers or the server clusters corresponding to the units, and the plurality of servers or server clusters corresponding to the units constitute the distance metric module to form the inter-node distance metric system provided by the present disclosure.

In an alternative embodiment, some of the above-mentioned units may together constitute a server or a server cluster.

In the present embodiment, the scheduling center endows the reciprocal value of the data transmission rate, the round-trip time and the packet loss rate with a first weight, a second weight and a third weight respectively and performs summing on the reciprocal value of the data transmission rate, the round-trip time and the packet loss rate to calculate the distance between the two nodes, wherein the first weight, the second weight and the third weight can be adjusted as required to more accurately and reliably calculate the distance between the nodes. For example, if the network environment changes (for instance, network operators adjust the network environments in different areas), the influence proportions of the reciprocal value of the data transmission rate, the round-trip time and the packet loss rate to the inter-node distance metric inevitably changes, so that the influence proportions of the reciprocal value of the data transmission rate, the round-trip time and the packet loss rate to the inter-node distance metric can be adjusted by adjusting the first weight, the second weight and the third weight, thereby calculating the distance between the two nodes more accurately and reliably.

In some embodiments, the first weight, the second weight and the third weight are dynamically changed, and satisfy the following formula:

αi=Ai βi=Bi γi=Ci, and

α′0=A0 β′0=B0 γ′0=C0, wherein

α′i is determined based on α′i-1 and αi, β′i is determined based on β′i-1 and βi, and γ′i is determined based on γ′i-1 and γi; and

α′i is an i-th value of the first weight, β′i is an i-th value of the second weight, γ′i is an i-th value of the third weight, αi represents a first reference weight, βi represents a second reference weight, γi represents a third reference weight, Ai, Bi and Ci are values determined based on a reference model established based on a relationship between inter-node distances in a plurality of nodes and inter-node historical transmission rates, and a relationship between inter-node historical round-trip times and inter-node historical packet loss rates, and i may be selected from 1 to N.

In some embodiments, the step that α′i is determined based on α′i-1 and αi, β′i is determined based on β′i-1 and βi, and γ′i is determined based on γ′i-1 and γi is embodied as:

α′i=(K−1)/Kα′i−1+1/Kαi,

β′i=(K−1)/Kβ′i−1+1/Kβi,

and

γ′i=(K−1)/Kγ′i−1+1/Kγi,

wherein
K is a positive integer.

In the present embodiment, by setting a weighting factor, (K−1)/K, for a former weight and a weighting factor, 1/K, for a currently calculated weight as well as weight-summing to determine a practically used weight, the finally obtained practically used weight is relatively closer to the former weight (because (K−1)/K is greater than or equal to 1/K), so as to avoid much difference between the practically used weight and the former weight. Thus, weight change caused by sudden change (non-normal adjustment) of the network environment is avoided, thereby ensuring the inter-node distance metric accuracy and reliability.

In some embodiments, the sum of the first weight, the second weight and the third weight is 1. That is, the first, second and third weights are subjected to a normalization processing, so as to more reasonably adjust the proportion among the reciprocal value of a data transmission rate, a round-trip time and a packet loss rate.

In the embodiments of the present disclosure, related function modules can be implemented by a hardware processor.

FIG. 5 is an architecture drawing 500 of the inter-node distance metric method and system provided by the embodiments of the present disclosure. The architecture drawing includes a scheduling center 510, a CDN node group 520 and a client 530, wherein the scheduling center 510 includes scheduling servers 511-51j, and the CDN node group 520 includes CDN nodes 521-52i. In the architecture drawing of the system, the scheduling center acquires a data transmission rate, a round-trip time and a packet loss rate between a first node and a second node (any two nodes in the CDN nodes). One of scheduling servers calculates the distance between the first node and the second node based on the data transmission rate, the round-trip time and the packet loss rate, wherein the data transmission rate is inversely proportional to the distance, and the round-trip time and the packet loss rate are proportional to the distance.

The embodiments of the present disclosure also provide a non-transitory computer-readable storage medium. One or more programs including execution instructions are stored in the storage medium, and the execution instructions may be read and executable by electronic equipment (including but not limited to a computer, a server, network equipment or the like) for executing related steps of the method in the above embodiments. The steps include:

acquiring a data transmission rate, a round-trip time and a packet loss rate between a first node and a second node; and

calculating a distance between the first node and the second node based on the data transmission rate, the round-trip time and the packet loss rate, wherein the data transmission rate is inversely proportional to the distance, and the round-trip time and the packet loss rate are proportional to the distance.

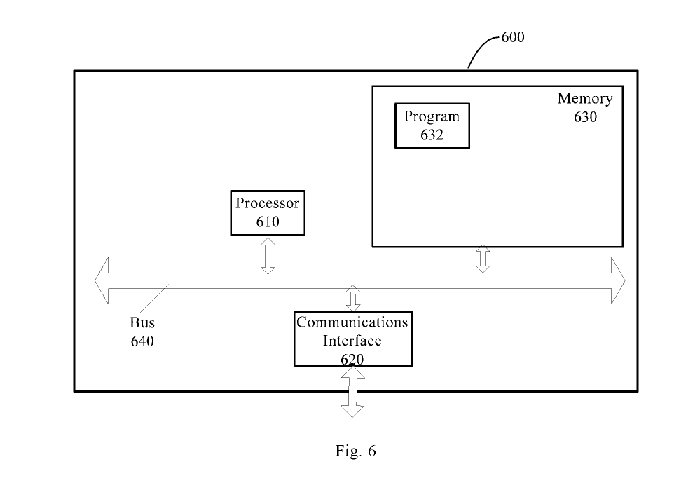

The embodiments of the present disclosure also provide electronic equipment (including but not limited to a computer, a server, network equipment or the like). FIG. 6 shows a schematic structural drawing of the electronic equipment according to an embodiment of the present disclosure. The embodiments of the application do not limit specific implementation of the electronic equipment 600. The electronic equipment 600 may include a processor 610, a communications interface 620, a memory 630, and a communication bus 640.

The processor 610, the communications interface 620 and the memory 630 are communicated with one another via the communication bus 640.

The communications interface 620 is configured to communicate with a network element, such as a client.

The processor 610 is configured to execute a program 632 in the memory 630, and specifically, can execute the related steps of the method in the above embodiments.

Particularly, the program 632 may include a program code including a computer operation instruction.

The processor 610 may be a central processing unit (CPU), an ASIC (Application Specific Integrated Circuit), or one or more integrated circuits configured to implement the embodiments of the application.

An inter-code distance metric device in the above embodiments includes:

a memory configured to store a computer operation instruction, and a

a processor configured to execute the computer operation instruction stored in the memory so as to execute:

acquiring a data transmission rate, a round-trip time and a packet loss rate between a first node and a second node; and

calculating the distance between the first node and the second node based on the data transmission rate, the round-trip time and the packet loss rate, wherein the data transmission rate is inversely proportional to the distance, and the round-trip time and the packet loss rate are proportional to the distance.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the present disclosure can be provided as method, system, or computer program product. Therefore, the present disclosure can be implemented in various ways, such as purely by hardware, or purely by software, or a combination of software and hardware. Moreover, the present disclosure can be implemented as a computer program product including one or more computer executable program codes which are stored on a computer readable memory medium (including but not limited to a disk storage or optic memory, etc.).

The present disclosure is described in reference to method, device (or system), and flow chart and/or block diagram of computer program product of embodiment of the disclosure. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. An inter-node distance metric method, comprising:
acquiring a data transmission rate, a round-trip time, and a packet loss rate between a first node and a second node; and
calculating a distance between the first node and the second node based on the data transmission rate, the round-trip time, and the packet loss rate, wherein the data transmission rate is inversely proportional to the distance, and the round-trip time and the packet loss rate are proportional to the distance.

2. The inter-node distance metric method of claim 1, wherein said calculating the distance between the first node and the second node based on the data transmission rate, the round-trip time and the packet loss rate comprises:
endowing a reciprocal value of the data transmission rate, the round-trip time and the packet loss rate with a first weight, a second weight, and a third weight respectively; and
weight-summing the reciprocal value of the data transmission rate, the round-trip time and the packet loss rate to obtain a sum value, and calculating the distance between the first node and the second node based on the obtained sum value.

3. The inter-node distance metric method of claim 2, wherein the first weight, the second weight, and the third weight respectively are:
αi=Ai βi=Bi γi=Ci, and
α′0=A0 β′0=B0 γ′0=C0, wherein
α′i is determined based on α′i-1 and αi, β′i is determined based on β′i-1 and βi, γ′i is determined based on γ′i-1 and γi; and i may be selected from 1 to N; and
α′i is an i-th value of the first weight, β′i is an i-th value of the second weight, γ′i is an i-th value of the third weight, αi represents a first reference weight, βi represents a second reference weight, γi represents a third reference weight, and Ai, Bi and Ci are values determined based on a reference model established based on a relationship between inter-node distances in a plurality of nodes and inter-node historical transmission rates, and a relationship between inter-node historical round-trip times and inter-node historical packet loss rates.

4. The inter-node distance metric method of claim 3, the step that α′i is determined based on α′i-1 and αi, β′i is determined based on β′i-1 and βi, and γ′i is determined based on γ′i-1 and γi is embodied as:
α′i=(K−1)/Kα′i−1+1/Kαi,
β′i=(K−1)/Kβ′i−1+1/Kβi,
and
γ′i=(K−1)/Kγ′i−1+1/Kγi,
wherein
K is a positive integer.

5. The inter-node distance metric method of claim 2, wherein the sum of the first weight, the second weight, and the third weight is 1.

6. An electronic device for estimating inter-node distance metric, comprising: at least one processor; and a memory communicably connected with the at least one processor for storing instructions executable by the at least one processor, wherein execution of the instructions by the at least one processor causes the at least one processor to:
acquire a data transmission rate, a round-trip time and a packet loss rate between a first node and a second node; and
calculate a distance between the first node and the second node based on the data transmission rate, the round-trip time and the packet loss rate, wherein the data transmission rate is inversely proportional to the distance, and the round-trip time and the packet loss rate are proportional to the distance.

7. The electronic device of claim 6, wherein the one or more processors are configured to:
endow a reciprocal value of the data transmission rate, the round-trip time and the packet loss rate with a first weight, a second weight and a third weight respectively; and
perform weight-summing on the reciprocal value of the data transmission rate, the round-trip time and the packet loss rate to obtain a sum value, and calculate the distance between the first node and the second node based on the obtained sum value.

8. The electronic device of claim 7, wherein the first weight, the second weight and the third weight respectively are:
αi=Ai βi=Bi γi=Ci, and
α′0=A0 β′0=B0 γ′0=C0, wherein
α′i is determined based on α′i-1 and αi, β′i is determined based on β′i-1 and βi, γ′i is determined based on γ′i-1 and γi; and i may be selected from 1 to N; and
α′i is an i-th value of the first weight, β′i is an i-th value of the second weight, γ′i is an i-th value of the third weight, αi represents a first reference weight, Pi represents a second reference weight, γi represents a third reference weight, and Ai, Bi and Ci are values determined based on a reference model established based on a relationship between inter-node distances in a plurality of nodes and inter-node historical transmission rates, and a relationship between inter-node historical round-trip times and inter-node historical packet loss rates.

9. The electronic device of claim 8, the step that α′i is determined based on α′i-1 and αi, β′i is determined based on β′i-1 and βi, and γ′i is determined based on γ′i-1 and γi is embodied as:
α′i=(K−1)/Kα′i−1+1/Kαi,
β′i=(K−1)/Kβ′i−1+1/Kβi,
and
γ′i=(K−1)/Kγ′i−1+1/Kγi,
wherein
K is a positive integer.

10. The electronic device of claim 6, wherein the sum of the first weight, the second weight and the third weight is 1.

11. A non-transitory computer-readable storage medium storing executable instructions, wherein the executable instructions, when executed by an electronic device comprising a processor, cause the electronic device to:
acquire a data transmission rate, a round-trip time and a packet loss rate between a first node and a second node; and
calculate a distance between the first node and the second node based on the data transmission rate, the round-trip time and the packet loss rate, wherein the data transmission rate is inversely proportional to the distance, and the round-trip time and the packet loss rate are proportional to the distance.

12. The non-transitory computer-readable storage medium according to claim 11, wherein the executable instructions, when executed by the electronic device, before receiving a plurality of task submitting requests from a plurality of users, further cause the electronic device to:
endow a reciprocal value of the data transmission rate, the round-trip time and the packet loss rate with a first weight, a second weight and a third weight respectively; and
perform weight-summing on the reciprocal value of the data transmission rate, the round-trip time and the packet loss rate to obtain a sum value, and calculate the distance between the first node and the second node based on the obtained sum value.

13. The non-transitory computer-readable storage medium of claim 12, wherein the first weight, the second weight, and the third weight respectively are:
αi=Ai βi=Bi γi=Ci, and
α′0=A0 β′0=B0 γ′0=C0, wherein
α′i is determined based on α′i-1 and αi, β′i is determined based on β′i-1 and βi, γ′i is determined based on γ′i-1 and γi; and i may be selected from 1 to N; and
α′i is an i-th value of the first weight, β′i is an i-th value of the second weight, γ′i is an i-th value of the third weight, αi represents a first reference weight, βi represents a second reference weight, γi represents a third reference weight, and Ai, Bi and Ci are values determined based on a reference model established based on a relationship between inter-node distances in a plurality of nodes and inter-node historical transmission rates, and a relationship between inter-node historical round-trip times and inter-node historical packet loss rates.

14. The non-transitory computer-readable storage medium of claim 13, wherein the executable instructions, when executed by a electronic device, further cause the electronic device to determine α′i, β′i, and γ′i using equations comprising:
α′i=(K−1)/Kα′i−1+1/Kαi,
β′i=(K−1)/Kβ′i−1+1/Kβi,
and
γ′i=(K−1)/Kγ′i−1+1/Kγi,
wherein K is a positive integer.

15. The non-transitory computer-readable storage medium of claim 12, wherein the sum of the first weight, the second weight and the third weight is 1.
